(19) United States
(12) Patent Application Publication
(10) Pub. No.: US 2025/0328600 A1
(43) Pub. Date: Oct. 23, 2025

(54) TIME SEQUENCE PREDICTION METHOD AND APPARATUS FOR SERVICE RESOURCE INDICATOR, AND DEVICE

(71) Applicants: Beijing Zitiao Network Technology Co., Ltd., Beijing (CN); Lemon Inc., Grand Cayman (KY); SHANGHAI JIAO TONG UNIVERSITY, Shanghai (CN)

(72) Inventors: Fuxin JIANG, Beijing (CN); Tieying ZHANG, Los Angeles, CA (US); Jianjun CHEN, Los Angeles, CA (US); Hengyu YE, Shanghai (CN); Jiadong CHEN, Shanghai (CN); Xiaofeng GAO, Shanghai (CN)

(21) Appl. No.: 18/972,576

(22) Filed: Dec. 6, 2024

(30) Foreign Application Priority Data
Apr. 18, 2024 (CN) 202410472029.3

(51) Int. Cl. G06F 17/14; G06F 5/01

(52) U.S. Cl. CPC G06F 17/141; G06F 5/01

(57) ABSTRACT

A time sequence prediction method and apparatus for a service resource indicator, and a device. The method includes: obtaining a first indicator sequence monitored in a service, the first indicator sequence being used to characterize a measurement value of a specified resource indicator of the service within a historical preset time period; invoking a time domain prediction model to perform prediction based on a time domain feature of the first indicator sequence to obtain a first prediction sequence of the specified resource indicator within a future preset time period; invoking a frequency domain prediction model to perform prediction based on a frequency domain feature of the first indicator sequence to obtain a second prediction sequence of the specified resource indicator within the future preset time period; and weighting the first prediction sequence and the second prediction sequence to obtain a prediction sequence corresponding to the service.

### CROSS-REFERENCE TO RELATED APPLICATION

The present application claims priority to Chinese patent application No. 202410472029.3 filed on Apr. 18, 2024, the disclosure of which is incorporated by reference herein in its entirety as part of the present application.

### TECHNICAL FIELD

Embodiments of the present disclosure relate to the field of data analysis technology, and in particular, to a time sequence prediction method and apparatus for a service resource indicator, and a device.

### BACKGROUND

A time sequence prediction method for a service resource indicator is used in multiple fields such as finance, economy, climate science, and cloud computing to predict an indicator condition in a specific future time period, so as to better adjust a corresponding service requirement.

An existing prediction method captures a small amount of information in a prediction process, and is low in accuracy; therefore, an actual prediction result is poor in applicability, which directly affects a service execution effect.

### SUMMARY

Embodiments of the present disclosure provide a time sequence prediction method and apparatus for a service resource indicator, and a device to improve the accuracy of a prediction sequence.

In a first aspect, an embodiment of the present disclosure provides a time sequence prediction method for a service resource indicator. The method includes:
obtaining a first indicator sequence monitored in a service, where the first indicator sequence is used to characterize a measurement value of a specified resource indicator of the service within a historical preset time period;
invoking a time domain prediction model to perform prediction based on a time domain feature of the first indicator sequence to obtain a first prediction sequence of the specified resource indicator generated by the service within a future preset time period;
invoking a frequency domain prediction model to perform prediction based on a frequency domain feature of the first indicator sequence to obtain a second prediction sequence of the specified resource indicator generated by the service within the future preset time period; and
weighting the first prediction sequence and the second prediction sequence to obtain a prediction sequence corresponding to the service, where the prediction sequence is used to guide the service to adjust the specified resource indicator.

In a second aspect, an embodiment of the present disclosure provides a time sequence prediction apparatus for a service resource indicator. The apparatus includes:
an obtaining module, configured to obtain a first indicator sequence monitored in a service, where the first indicator sequence is used to characterize a measurement value of a specified resource indicator of the service within a historical preset time period;
a first determination module, configured to invoke a time domain prediction model to perform prediction based on a time domain feature of the first indicator sequence to obtain a first prediction sequence of the specified resource indicator generated by the service within a future preset time period;
a second determination module, configured to invoke a frequency domain prediction model to perform prediction based on a frequency domain feature of the first indicator sequence to obtain a second prediction sequence of the specified resource indicator generated by the service within the future preset time period; and
a prediction module, configured to weight the first prediction sequence and the second prediction sequence to obtain a prediction sequence corresponding to the service, where the prediction sequence is used to guide the service to adjust the specified resource indicator.

In a third aspect, an embodiment of the present disclosure provides an electronic device. The electronic device includes:
a processor, and a memory communicatively connected to the processor,
where the memory stores computer executable instructions; and
the processor executes the computer executable instructions stored in the memory to implement
the time sequence prediction method for a service resource indicator according to the first aspect described above.

In a fourth aspect, an embodiment of the present disclosure provides a computer-readable storage medium. Computer executable instructions are stored in the computer-readable storage medium. When the computer executable instructions are executed by a processor, the time sequence prediction method for a service resource indicator according to the first aspect described above is implemented.

In a fifth aspect, an embodiment of the present disclosure provides a computer program product. The computer program product includes a computer program. When the computer program is executed by a processor, the time sequence prediction method for a service resource indicator according to the first aspect described above is implemented.

The embodiments provide a time sequence prediction method and apparatus for a service resource indicator, and a device. The method includes: obtaining a first indicator sequence monitored in a service, where the first indicator sequence is used to characterize a measurement value of a specified resource indicator of the service within a historical preset time period; invoking a time domain prediction model to perform prediction based on a time domain feature of the first indicator sequence to obtain a first prediction sequence of the specified resource indicator generated by the service within a future preset time period; invoking a frequency domain prediction model to perform prediction based on a frequency domain feature of the first indicator sequence to obtain a second prediction sequence of the specified resource indicator generated by the service within the future preset time period; and weighting the first prediction sequence and the second prediction sequence to obtain a prediction sequence corresponding to the service, where the prediction sequence is used to guide the service to adjust the specified resource indicator. In the embodiments of the present application, the first prediction sequence is determined by the time domain feature of the first indicator sequence, the second prediction sequence is determined by the frequency domain feature of the first indicator sequence, and then the first prediction sequence and the second prediction sequence are weighted to obtain the prediction sequence corresponding to the service. The features and weights in the two dimensions of the time domain and the frequency domain are considered comprehensively. The time domain feature can improve local dependency of the prediction sequence, and the frequency domain feature can improve global correlation of the prediction sequence. The prediction sequence corresponding to the service is determined by combining the local dependency and the global correlation, so that the accuracy of the prediction sequence can be improved.

### BRIEF DESCRIPTION OF DRAWINGS

In order to illustrate the technical solutions in the embodiments of the present disclosure or in the prior art more clearly, the following briefly introduces the drawings required for describing the embodiments or the prior art. Apparently, the drawings in the following description are some embodiments of the present disclosure, and for those of ordinary skill in the art, other drawings may further be obtained according to these drawings without creative efforts.

FIG. 1 is a schematic diagram of an application scenario of a time sequence prediction method for a service resource indicator according to an embodiment of the present disclosure;

FIG. 2 is a flowchart of a time sequence prediction method for a service resource indicator according to an embodiment of the present disclosure;

FIG. 3 is a schematic diagram of a time sequence prediction method for a service resource indicator according to an embodiment of the present disclosure;

FIG. 4 is a flowchart of another time sequence prediction method for a service resource indicator according to an embodiment of the present disclosure;

FIG. 5 is a block diagram of a structure of a time sequence prediction apparatus for a service resource indicator according to an embodiment of the present disclosure; and

FIG. 6 is a schematic diagram of a hardware structure of an electronic device according to an embodiment of the present disclosure.

### DETAILED DESCRIPTION

In order to make the purposes, technical solutions, and advantages of the embodiments of the present disclosure clearer, the technical solutions in the embodiments of the present disclosure will be described clearly and completely below with reference to the drawings in the embodiments of the present disclosure. Apparently, the described embodiments are merely some embodiments of the present disclosure, rather than all the embodiments. All other embodiments obtained by those of ordinary skill in the art based on the embodiments of the present disclosure without creative efforts shall fall within the protection scope of the present disclosure.

It should be noted that user information (including but not limited to user equipment information, user personal information, and the like) and data (including but not limited to data for analysis, stored data, displayed data, and the like) involved in the present application are information and data authorized by the user or fully authorized by parties. The collection, use, and processing of related data need to comply with relevant laws, regulations, and standards, and corresponding operation entry is provided for the user to choose to authorize or reject.

In the field of data analysis technology, a long-term time sequence prediction method is an important prediction method in multiple fields such as finance, economy, climate science, and resource planning.

An existing prediction method captures a small amount of information in a prediction process and is low in accuracy; therefore, an actual prediction result is poor in applicability, which directly affects a service execution effect. Therefore, how to improve the accuracy of time sequence prediction is a technical problem that needs to be solved urgently at present.

To solve the above problem, this embodiment provides the following technical concept: when time sequence prediction is performed, the features and weights of the two dimensions of the time domain and the frequency domain may be considered comprehensively. The local dependency of the prediction sequence can be improved through the time domain feature, and the global correlation of the prediction sequence can be improved through the frequency domain feature. Determining the prediction sequence corresponding to the service in combination with the local dependency and the global correlation is implemented.

Correspondingly, specific steps may include: first, obtaining a first indicator sequence monitored in a service, where the first indicator sequence is used to characterize a measurement value of a specified resource indicator of the service within a historical preset time period; then, invoking a time domain prediction model to perform prediction based on a time domain feature of the first indicator sequence to obtain a first prediction sequence of the specified resource indicator generated by the service within a future preset time period; and invoking a frequency domain prediction model to perform prediction based on a frequency domain feature of the first indicator sequence to obtain a second prediction sequence of the specified resource indicator generated by the service within the future preset time period. Finally, weighting the first prediction sequence and the second prediction sequence to obtain a prediction sequence corresponding to the service, where the prediction sequence is used to guide the service to adjust the specified resource indicator.

In this case, the first prediction sequence is determined by the time domain feature of the first indicator sequence, the second prediction sequence is determined by the frequency domain feature of the first indicator sequence, and then the first prediction sequence and the second prediction sequence are weighted to obtain the prediction sequence corresponding to the service. The features and weights in the two dimensions of the time domain and the frequency domain are considered comprehensively. The time domain feature can improve local dependency of the prediction sequence, and the frequency domain feature can improve global correlation of the prediction sequence. The prediction sequence corresponding to the service is determined by combining the local dependency and the global correlation, so that the accuracy of the prediction sequence can be improved.

The application scenario of the embodiments of the present disclosure will be explained below.

The time sequence prediction method for a service resource indicator provided in the embodiments of the present disclosure may be applied to a scenario in which various time sequence are predicted. For example, the number of users who browse an XX Internet platform may be predicted. FIG. 1 is a schematic diagram of an application scenario of a time sequence prediction method for a service resource indicator according to an embodiment of the present disclosure. As shown in FIG. 1, a terminal 101 and a server 102 may be connected by wire or wirelessly. A user may send a sequence prediction request to the server 102 by using the terminal 101. The server 102 performs, by using the time sequence prediction method for a service resource indicator provided in the embodiments of the present disclosure, prediction according to an input sequence (which may be the number of users who browse the Internet platform within the past week) to obtain a prediction sequence (the number of users who browse the Internet platform within the next week). The server 102 returns the prediction sequence to the terminal 101, and the terminal 101 receives and displays the prediction sequence. The time sequence prediction method for a service resource indicator provided in the embodiments of the present disclosure will be described in detail below by using detailed embodiments.

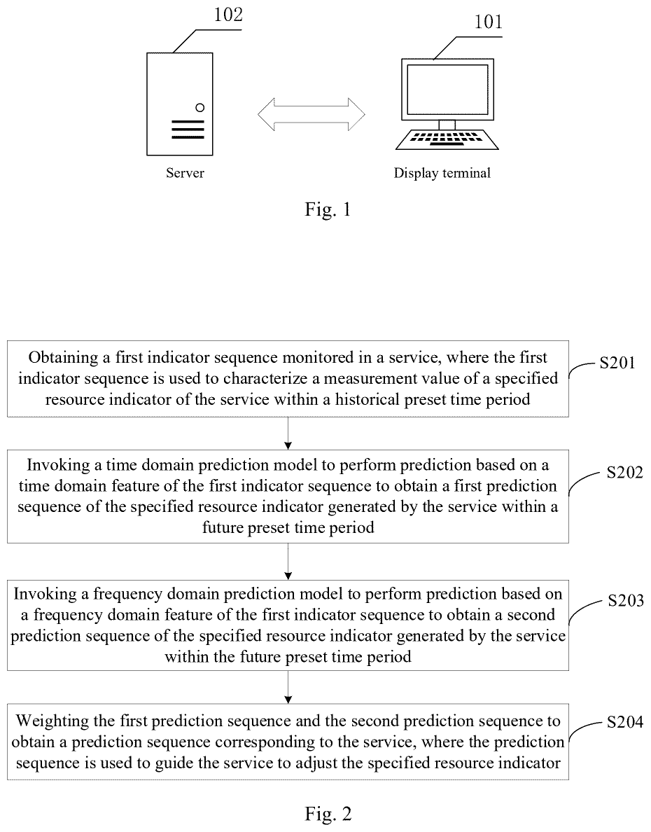

FIG. 2 is a flowchart of a time sequence prediction method for a service resource indicator according to an embodiment of the present disclosure. An execution subject of the method may be a terminal or a server. The embodiments of the present application are described by using an example in which the execution subject is a server. As shown in FIG. 2, the method includes the following steps.
S201: Obtaining a first indicator sequence monitored in a service, where the first indicator sequence is used to characterize a measurement value of a specified resource indicator of the service within a historical preset time period.

In the embodiment of the present disclosure, the first indicator sequence may be a time sequence corresponding to the measurement value of the specified resource indicator within the historical preset time period. For example, the first indicator sequence may be a time sequence corresponding to the number of users who browse an Internet platform A, or the first indicator sequence may be a time sequence corresponding to the number of video views of a video platform B, or the first indicator sequence may be a time sequence corresponding to a measurement value of load information of a target container within the historical preset time period.

The historical preset time period corresponds to a plurality of measurement time points, and the measurement value of the specified resource indicator within the historical preset time period is a measurement value corresponding to the plurality of measurement time points. For example, the first indicator sequence may be a time sequence corresponding to the number of users who browse the Internet platform A, the historical preset time period is 30 minutes, and the first indicator sequence is the number of users who browse the Internet platform per minute. In this case, each minute of the historical preset time period corresponds to one measurement time point, and the number of the plurality of measurement time points is 30. In the embodiment of the present disclosure, the historical preset time period, the number of the plurality of measurement points, and a time interval between two adjacent measurement points are not specifically limited.
S202: Invoking a time domain prediction model to perform prediction based on a time domain feature of the first indicator sequence to obtain a first prediction sequence of the specified resource indicator generated by the service within a future preset time period.

In some embodiments, the first indicator sequence may be segmented first, and then the first prediction sequence of the specified resource indicator generated by the service within the future preset time period is obtained by using the time domain prediction model. Correspondingly, this step may include: segmenting the first indicator sequence into N sub-indicator sequences each with a preset length, where N is a positive integer; performing linear transformation processing on the N sub-indicator sequences with the preset length to obtain N vectors corresponding to the N sub-indicator sequences; and obtaining the first prediction sequence of the specified resource indicator generated by the service within the future preset time period according to the N vectors corresponding to the N sub-indicator sequences and the time domain prediction model.

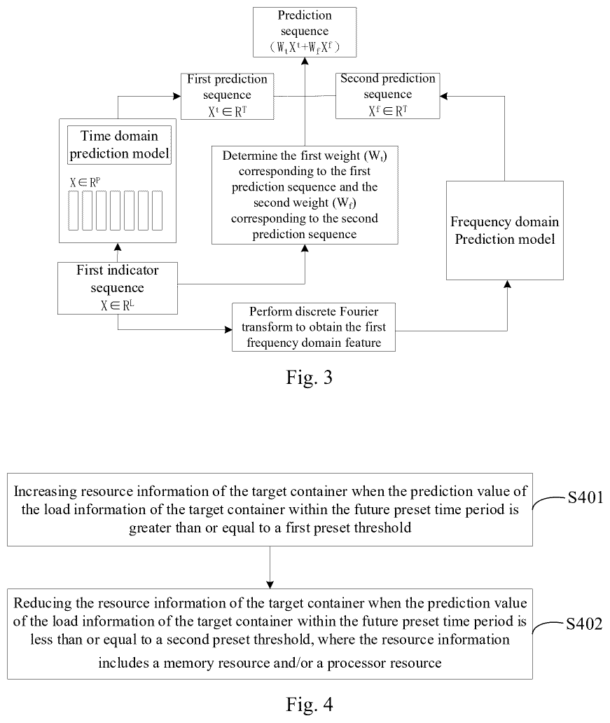

The first prediction sequence is a prediction sequence related to the time domain. Exemplarily, as shown in FIG. 3, the first indicator sequence may be represented as: X∈R^{L}, where L represents the historical preset time period. The N sub-indicator sequences may be represented as: X∈R^{P}, where P represents a length of the sub-indicator sequence.

Optionally, the time domain prediction model may be an attention model. The N vectors corresponding to the N sub-indicator sequences are inputted to the attention model, and the first prediction sequence within the future preset time period may be outputted. Exemplarily, the first prediction sequence may be represented as: X^{t}∈R^{T}, where T represents the future preset time period.

The values of the historical preset time period and the future preset time period are not specifically limited in the embodiments of the present disclosure. Exemplarily, the historical preset time period is one month, and the future preset time period is one week.

Further, to improve the accuracy of the obtained first prediction sequence, the N sub-indicator sequences may be first normalized, and then the first prediction sequence within the future preset time period is obtained by using the time domain prediction model. Correspondingly, the obtaining the first prediction sequence of the specified resource indicator generated by the service within the future preset time period according to the N vectors corresponding to the N sub-indicator sequences and the time domain prediction model may include: normalizing the N vectors corresponding to the N sub-indicator sequences to obtain N normalized vectors; and obtaining the first prediction sequence of the specified resource indicator generated by the service within the future preset time period according to the N normalized vectors and the time domain prediction model.

Optionally, the N vectors corresponding to the N sub-indicator sequences are normalized by using the reversible instance normalization (RevIN). In the embodiment of the present disclosure, the N vectors corresponding to the N sub-indicator sequences are normalized, so that uniform distribution of the N vectors can be implemented, and the accuracy of the first prediction sequence can be further improved.
S203: Invoking a frequency domain prediction model to perform prediction based on a frequency domain feature of the first indicator sequence to obtain a second prediction sequence of the specified resource indicator generated by the service within the future preset time period.

In some embodiments, the first indicator sequence may be first processed by using discrete Fourier transform to obtain the frequency domain feature aligned with the frequency domain of the first indicator sequence, and then the frequency domain prediction model is invoked to obtain the second prediction sequence based on the aligned frequency domain feature. Correspondingly, this step includes the following steps (1) and (2).
(1) Perform discrete Fourier transform on the first indicator sequence to obtain a first frequency domain feature aligned with a frequency domain of the first indicator sequence, where a length of the first frequency domain feature matches a sum of a length of the first indicator sequence and a length of the second prediction sequence to be predicted.

Optionally, this step may include: performing discrete Fourier transform on the first indicator sequence to obtain the first frequency domain feature aligned with the frequency domain of the first indicator sequence according to the following formula 1:

$$F ( k ) = {\sum }_{n = 0}^{L - 1} x [ n ] {e}^{- 2 π i \frac{k n}{L + T}} ; \qquad Formula 1$$

where k=0, 1, . . . , L+T−1; n=0, 1, . . . , L−1; L represents the length of the first indicator sequence; T represents the length of the second prediction sequence to be predicted; x[n] represents the first indicator sequence; and F(k) represents the first frequency domain feature.

Optionally, the length of the first frequency domain feature matching the sum of the length of the first indicator sequence and the length of the second prediction sequence to be predicted may be represented as: the length of the first frequency domain feature being equal to the sum of the length of the first indicator sequence and the length of the second prediction sequence to be predicted.

In some embodiments, the first frequency domain feature includes a plurality of one-dimensional frequency spectrums, and the length of the one-dimensional frequency spectrum is equal to the sum of the length of the first indicator sequence and the length of the second prediction sequence to be predicted. Exemplarily, the first frequency domain feature may include a plurality of one-dimensional complex frequency spectrums. The one-dimensional complex frequency spectrum is a symmetric spectrum and may be represented as F∈C^{\hat{L}}, where \hat{L}=[(L+T)/2]+1 represents half the length of the one-dimensional complex frequency spectrum.

It should be noted that the length of the frequency domain of the first indicator sequence includes a sum of the length of the first indicator sequence and the length of the second prediction sequence to be predicted. The frequency domain of the first indicator sequence may also be referred to as a complete frequency domain of the first indicator sequence.

In the prior art, when the discrete Fourier transform is performed on the first indicator sequence, the length of the second prediction sequence to be predicted is generally not considered, the length of the obtained frequency domain feature is equal to the length of the first indicator sequence, and a frequency shift between the obtained frequency domain feature and the complete frequency domain of the first indicator sequence causes a low accuracy of the prediction sequence obtained by using the frequency domain feature with the frequency shift.

In the embodiments of the present disclosure, the first indicator sequence is processed by using the extended discrete Fourier transform to obtain the first frequency domain feature aligned with the frequency domain of the first indicator sequence. The length of the first frequency domain feature matches the sum of the length of the first indicator sequence and the length of the second prediction sequence to be predicted, so that the frequency shift between the first frequency domain feature and the complete frequency domain can be avoided, thereby improving the accuracy of the prediction sequence.
(2) Obtain the second prediction sequence of the specified resource indicator generated by the service within the future preset time period according to the first frequency domain feature and the frequency domain prediction model.

In some embodiments, this step may include the following steps (a) to (c).
(a) Perform linear transformation on the first frequency domain feature to obtain the second frequency domain feature of the target dimension matching the input parameter of the frequency domain prediction model.

Optionally, the target dimension may be represented as D, and linear transformation may be performed on the first frequency domain feature by using a preset matrix, to obtain the second frequency domain feature of the target dimension. Exemplarily, the preset matrix may be represented as W∈C^{D×L}, and the first frequency domain feature may be represented as F∈C^{\hat{L}}. The linear transformation is performed on F∈C^{\hat{L}} by using W∈C^{D×\hat{L}}, and the second frequency domain feature of the target dimension may be represented as F∈C^{D}.
(b) Obtain a prediction frequency domain feature of the specified resource indicator generated by the service within the future preset time period according to the second frequency domain feature of the target dimension and the frequency domain prediction model.

Optionally, this step may include: using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism.

In some embodiments, the frequency domain prediction model is a multi-head attention mechanism, and the multi-head attention mechanism includes a preset number of vector groups, where one vector group includes one query vector, one key vector, and one value vector. Correspondingly, the using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism includes: determining, for each vector group, a first product of the second frequency domain feature and the query vector in the vector group, and determining a second product of the second frequency domain feature and the key vector in the vector group, and determining a third product of the second frequency domain feature and the value vector in the vector group; and obtaining the prediction frequency domain feature of the specified resource indicator generated by the service within the future preset time period according to the first product, the second product, and the third product that respectively correspond to each vector group and the multi-head attention model.

The multi-head attention model includes a self-attention layer and a feedforward neural network layer. The dot product attention operation may be performed on the first product, the second product, and the third product by the self-attention layer, to obtain an attention output parameter of the self-attention layer. Then, after the attention output parameter is processed by M editors in the feedforward neural network layer, the prediction frequency domain feature is obtained.

Exemplarily, the preset number is h. The h vector groups include: query vectors

$${W}_{h}^{Q} ,$$

key vectors

$${W}_{h}^{K} ,$$

and value vectors

$${W}_{h}^{V} .$$

The dot product attention operation is performed on the first product, the second product, and the third product that respectively correspond to the h vector groups by using the following formula 2 to obtain the attention output parameter.

$${head}_{h} = Attention ( {Q}_{h} , {K}_{h} , {V}_{h} ) = Softmax ( \vert {Q}_{h} {K}_{h}^{T} \vert ) {V}_{h} \qquad Formula 2$$

The first product respectively corresponding to the h vector groups may be represented as

$${Q}_{h} = {F}_{d}^{T} {W}_{h}^{Q} ,$$

the second product respectively corresponding to the h vector groups may be represented as

$${K}_{h} = {F}_{d}^{T} {W}_{h}^{k} ,$$

and the third product respectively corresponding to the h vector groups may be represented as

$${V}_{h} = {F}_{d}^{T} {W}_{h}^{V} .$$

(c) Perform inverse Fourier transform on the prediction frequency domain feature to obtain the second prediction sequence of the specified resource indicator generated by the service within the future preset time period.

Exemplarily, the second prediction sequence obtained by performing inverse Fourier transform on the prediction frequency domain feature may be represented as: X^{f}∈R^{T}, where T represents the length of the second prediction sequence.
S204: Weighting the first prediction sequence and the second prediction sequence to obtain a prediction sequence corresponding to the service, where the prediction sequence is used to guide the service to adjust the specified resource indicator.

Optionally, the Fourier transform may be first performed on the first indicator sequence to obtain a third frequency domain feature, and then the weights of the first prediction sequence and the second prediction sequence are determined by analyzing the energy of a harmonic signal in the third frequency domain feature and the energy of a non-harmonic signal other than the harmonic signal in the third frequency domain feature.

Correspondingly, the weighting the first prediction sequence and the second prediction sequence to obtain a prediction sequence corresponding to the service may include: performing Fourier transform on the first indicator sequence to obtain a third frequency domain feature corresponding to the first indicator sequence, where the third frequency domain feature includes a periodic harmonic signal and a non-harmonic signal other than the harmonic signal; determining a first energy parameter corresponding to the non-harmonic signal in the third frequency domain feature and a second energy parameter corresponding to the harmonic signal in the third frequency domain feature; and determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

Optionally, the determining a first energy parameter corresponding to the non-harmonic signal in the third frequency domain feature and a second energy parameter corresponding to the harmonic signal in the third frequency domain feature includes: obtaining the first energy parameter according to the non-harmonic signal in the third frequency domain feature and the following formula 3; and obtaining the second energy parameter according to the harmonic signal in the third frequency domain feature and the following formula 4:

$${E}_{r} = {\sum }_{i ∉ {F}_{h}} {\vert F [ i ] \vert}^{2} ; \qquad Formula 3$$

$${E}_{h} = {\sum }_{i ∈ {F}_{h}} {\vert F [ i ] \vert}^{2} \qquad Formula 4$$

where Eᵣ represents the first energy parameter, Eₙ represents the second energy parameter, Fₕ=m, 2m, . . . , km, and k is a preset value; m=argmax|F[i]|, i≤(L/2)+1; L represents a length of an input sequence, F[i] represents a discrete Fourier transform function, and Fₕ represents the harmonic signal in the third frequency domain feature.

It should be noted that a higher energy (the second energy parameter) of the harmonic signal in the third frequency domain feature indicates a stronger periodicity of the first indicator sequence, and in this case, the weight of the second prediction sequence determined by frequency domain information needs to be increased. A lower energy (the second energy parameter) of the harmonic signal in the third frequency domain feature indicates a weaker periodicity of the first indicator sequence, and in this case, the weight of the second prediction sequence needs to be reduced.

In some embodiments, the determining a first weight corresponding to the first prediction sequence and a second weight corresponding to the second prediction sequence according to the first energy parameter and the second energy parameter includes: determining a total energy parameter of the first energy parameter and the second energy parameter; and determining a ratio of the first energy parameter to the total energy parameter as the first weight corresponding to the first prediction sequence, and determining a ratio of the second energy parameter to the total energy parameter as the second weight corresponding to the second prediction sequence.

Exemplarily, the first energy parameter may be represented as: X^{t}, the second energy parameter may be represented as: E_{f}, the first weight parameter corresponding to the first prediction sequence may be represented as: Wₜ, and the second weight parameter corresponding to the second prediction sequence is: W_{f}.

In some embodiments, the weighting the first prediction sequence and the second prediction sequence according to the first weight and the second weight to obtain the prediction sequence corresponding to the service includes: determining a first product between the first prediction sequence and the first weight, and determining a second product between the second prediction sequence and the second weight; and obtaining the prediction sequence corresponding to the service according to a sum of the first product and the second product.

Exemplarily, as shown in FIG. 4, the first prediction sequence may be represented as: X^{t}, and the second prediction sequence may be represented as: X^{f}. The first weight corresponding to the first prediction sequence may be represented as: Wₜ, and the second weight corresponding to the second prediction sequence may be represented as: W^{f}. Correspondingly, the prediction sequence corresponding to the service may be represented as: WₜX^{t}+W_{f}X^{f}.

In the embodiments of the present application, the first prediction sequence is determined by the time domain feature of the first indicator sequence, the second prediction sequence is determined by the frequency domain feature of the first indicator sequence, and then the first prediction sequence and the second prediction sequence are weighted to obtain the prediction sequence corresponding to the service. The features and weights in the two dimensions of the time domain and the frequency domain are considered comprehensively. The time domain feature can improve the local dependency of the prediction sequence, and the frequency domain feature can improve the global correlation of the prediction sequence. The prediction sequence corresponding to the service is determined by combining the local dependency and the global correlation, so that the accuracy of the prediction sequence can be improved.

It should be noted that the determined prediction sequence may be used to guide the service to adjust the specified resource indicator. In some embodiments, the first indicator sequence is used to characterize the measurement value of the load information of the target container within the historical preset time period, and the prediction sequence corresponding to the service includes the prediction value of the load information of the target container within the future preset time period. Correspondingly, as shown in FIG. 4, the method further includes the following steps.
S401: Increasing resource information of the target container when the prediction value of the load information of the target container within the future preset time period is greater than or equal to a first preset threshold.
S402: Reducing the resource information of the target container when the prediction value of the load information of the target container within the future preset time period is less than or equal to a second preset threshold, where the resource information includes a memory resource and/or a processor resource.

In the embodiment of the present disclosure, the prediction sequence may be used to guide the service to adjust the specified resource indicator. The accuracy of adjusting the specified resource indicator can be improved by improving the accuracy of the prediction sequence.

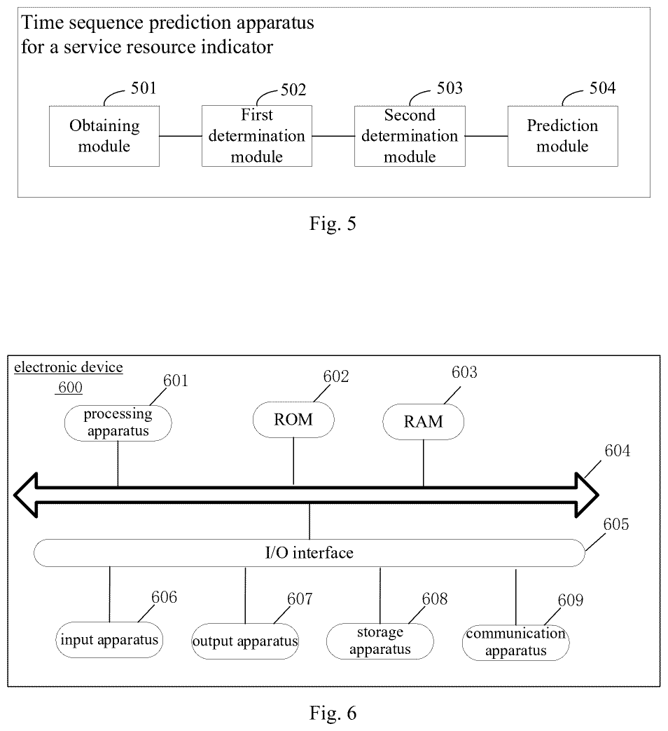

FIG. 5 is a block diagram of a structure of a time sequence prediction apparatus for a service resource indicator according to an embodiment of the present disclosure. The apparatus includes: an obtaining module 501, a first determination module 502, a second determination module 503, and a prediction module 504.

The obtaining module 501 is configured to obtain a first indicator sequence monitored in a service, where the first indicator sequence is used to characterize a measurement value of a specified resource indicator of the service within a historical preset time period.

The first determination module 502 is configured to invoke a time domain prediction model to perform prediction based on a time domain feature of the first indicator sequence to obtain a first prediction sequence of the specified resource indicator generated by the service within a future preset time period.

The second determination module 503 is configured to invoke a frequency domain prediction model to perform prediction based on a frequency domain feature of the first indicator sequence to obtain a second prediction sequence of the specified resource indicator generated by the service within the future preset time period.

The prediction module 504 is configured to weight the first prediction sequence and the second prediction sequence to obtain a prediction sequence corresponding to the service, where the prediction sequence is used to guide the service to adjust the specified resource indicator.

According to one or more embodiments of the present disclosure, the second determination module 503 invokes a frequency domain prediction model to perform prediction based on a frequency domain feature of the first indicator sequence to obtain a second prediction sequence of the specified resource indicator generated by the service within the future preset time period, specifically including: performing discrete Fourier transform on the first indicator sequence to obtain a first frequency domain feature aligned with a frequency domain of the first indicator sequence, where a length of the first frequency domain feature matches a sum of a length of the first indicator sequence and a length of the second prediction sequence to be predicted; and obtaining the second prediction sequence of the specified resource indicator generated by the service within the future preset time period according to the first frequency domain feature and the frequency domain prediction model.

According to one or more embodiments of the present disclosure, the second determination module 503 obtains the second prediction sequence of the specified resource indicator generated by the service within the future preset time period according to the first frequency domain feature and the frequency domain prediction model, specifically including: performing linear transformation on the first frequency domain feature to obtain a second frequency domain feature of a target dimension matching an input parameter of the frequency domain prediction model; obtaining a prediction frequency domain feature of the specified resource indicator generated by the service within the future preset time period according to the second frequency domain feature of the target dimension and the frequency domain prediction model; and performing inverse Fourier transform on the prediction frequency domain feature to obtain the second prediction sequence of the specified resource indicator generated by the service within the future preset time period.

According to one or more embodiments of the present disclosure, the second determination module 503 obtains a prediction frequency domain feature of the specified resource indicator generated by the service within the future preset time period according to the second frequency domain feature of the target dimension and the frequency domain prediction model, specifically including: using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism.

According to one or more embodiments of the present disclosure, the prediction module 504 weights the first prediction sequence and the second prediction sequence to obtain a prediction sequence corresponding to the service, specifically including: performing Fourier transform on the first indicator sequence to obtain a third frequency domain feature corresponding to the first indicator sequence, where the third frequency domain feature includes a periodic harmonic signal and a non-harmonic signal other than the harmonic signal; determining a first energy parameter corresponding to the non-harmonic signal in the third frequency domain feature and a second energy parameter corresponding to the harmonic signal in the third frequency domain feature; and determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

According to one or more embodiments of the present disclosure, the prediction module 504 determines a first weight corresponding to the first prediction sequence and a second weight corresponding to the second prediction sequence according to the first energy parameter and the second energy parameter, specifically including: determining a total energy parameter of the first energy parameter and the second energy parameter; and determining a ratio of the first energy parameter to the total energy parameter as the first weight corresponding to the first prediction sequence, and determining a ratio of the second energy parameter to the total energy parameter as the second weight corresponding to the second prediction sequence.

According to one or more embodiments of the present disclosure, the first determination module 502 invokes a time domain prediction model to perform prediction based on a time domain feature of the first indicator sequence to obtain a first prediction sequence of the specified resource indicator generated by the service within a future preset time period, specifically including: segmenting the first indicator sequence into N sub-indicator sequences each with a preset length, where N is a positive integer; performing linear transformation processing on the N sub-indicator sequences with the preset length to obtain N vectors corresponding to the N sub-indicator sequences; and obtaining the first prediction sequence of the specified resource indicator generated by the service within the future preset time period according to the N vectors corresponding to the N sub-indicator sequences and the time domain prediction model.

According to one or more embodiments of the present disclosure, the first determination module 502 obtains the first prediction sequence of the specified resource indicator generated by the service within the future preset time period according to the N vectors corresponding to the N sub-indicator sequences and the time domain prediction model, specifically including: normalizing the N vectors corresponding to the N sub-indicator sequences to obtain N normalized vectors; and obtaining the first prediction sequence of the specified resource indicator generated by the service within the future preset time period according to the N normalized vectors and the time domain prediction model.

According to one or more embodiments of the present disclosure, the first indicator sequence is used to characterize the measurement value of the load information of the target container within the historical preset time period, and the prediction sequence corresponding to the service includes the prediction value of the load information of the target container within the future preset time period. Correspondingly, the apparatus further includes: an adjustment module. The adjustment module is configured to: increase the resource information of the target container when the prediction value of the load information of the target container within the future preset time period is greater than or equal to a first preset threshold; and reduce the resource information of the target container when the prediction value of the load information of the target container within the future preset time period is less than or equal to a second preset threshold, where the resource information includes a memory resource and/or a processor resource.

FIG. 6 is a schematic diagram of a hardware structure of an electronic device according to an embodiment of the present disclosure. Referring to FIG. 6, the electronic device 600 may be a terminal device or a server. The terminal device may include, but is not limited to, a mobile terminal such as a mobile phone, a laptop, a digital broadcast receiver, a personal digital assistant (PDA), a tablet computer (Portable Android Device, or PAD for short), a portable media player (PMP), and a vehicle-mounted terminal (for example, a vehicle-mounted navigation terminal), and a fixed terminal such as a digital TV and a desktop computer. The electronic device shown in FIG. 6 is merely an example, and shall not impose any limitation on the function and range of use of the embodiments of the present disclosure.

As shown in FIG. 6, the electronic device 600 may include a processing apparatus (for example, a central processing unit, a graphics processing unit, etc.) 601. The processing apparatus 601 may perform various suitable actions and processing according to a program stored in a read-only memory (ROM) 602 or a program loaded from a storage apparatus 608 into a random-access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 such as a touchscreen, a touchpad, a keyboard, a mouse, a camera, a microphone, an accelerometer, and a gyroscope; an output apparatus 607 such as a liquid crystal display (LCD), a speaker, and a vibrator; the storage apparatus 608 such as a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that not all the apparatuses shown are required to be implemented or present. More or fewer apparatuses may be implemented or present alternatively.

In particular, according to the embodiments of the present disclosure, the process described above with reference to the flowchart may be implemented as a computer software program. For example, an embodiment of the present disclosure includes a computer program product, which includes a computer program carried on a computer-readable medium. The computer program includes program code for executing the method shown in the flowchart. In such an embodiment, the computer program may be downloaded and installed from the network through the communication apparatus 609, or installed from the storage apparatus 608, or installed from the ROM 602. When the computer program is executed by the processing apparatus 601, the above-mentioned functions defined in the method of the embodiment of the present disclosure are performed.

It should be noted that the computer-readable medium in the present disclosure may be a computer-readable signal medium, or a computer-readable storage medium, or any combination of the two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of the above. In the present disclosure, the computer-readable storage medium may be any tangible medium containing or storing a program. The program may be used by or used in conjunction with an instruction execution system, apparatus, or device. In the present disclosure, the computer-readable signal medium may include a data signal propagated in a baseband or as a part of a carrier, and computer-readable program code is carried in the data signal. The data signal propagated in this manner may be in various forms, including but not limited to an electromagnetic signal, an optical signal, or any appropriate combination of the above. The computer-readable signal medium may also be any computer-readable medium other than the computer-readable storage medium. The computer-readable signal medium may send, propagate, or transmit the program used by or used in conjunction with the instruction execution system, apparatus, or device. The program code contained on the computer-readable medium may be transmitted by using any suitable medium, including but not limited to: a wire, an optical cable, radio frequency (RF), or any appropriate combination of the above.

The computer-readable medium may be included in the electronic device or may exist alone without being assembled into the electronic device.

The above computer-readable medium carries one or more programs, and when the one or more programs are executed by the electronic device, the electronic device is enabled to execute the method shown in the above embodiments.

The computer program code for performing the operations of the present disclosure may be written in one or more programming languages or a combination thereof. The above programming languages include object-oriented programming languages such as Java, Smalltalk, and C++, as well as conventional procedural programming languages such as “C” language or similar programming languages. The program code may be executed entirely on a user computer, partly on a user computer, as a stand-alone software package, partly on a user computer and partly on a remote computer, or entirely on a remote computer or a server. In the case of the remote computer, the remote computer may be connected to the user computer through any kind of network, including a local area network (LAN) or a wide area network (WAN), or may be connected to an external computer (for example, via the Internet through an Internet service provider).

The flowcharts and block diagrams in the drawings illustrate possible architectures, functions, and operations of systems, methods, and computer program products according to various embodiments of the present disclosure. In this regard, each block in the flowchart or block diagram may represent a module, program segment, or part of code, and the module, program segment, or part of code contains one or more executable instructions for implementing a specified logical function. It should also be noted that, in some alternative implementations, the functions indicated in the blocks may occur in a different order than the order indicated in the drawings. For example, two blocks shown in succession may actually be executed substantially in parallel, and they may sometimes be executed in the reverse order, depending on the functions involved. It should also be noted that each block in the block diagram and/or flowchart, and the combination of blocks in the block diagram and/or flowchart, may be implemented by a dedicated hardware-based system that performs the specified functions or operations, or may be implemented by a combination of dedicated hardware and computer instructions.

The modules/units involved in the embodiments of the present disclosure may be implemented by software or hardware. The name of a module/unit does not constitute a limitation on the module/unit itself under certain circumstances. For example, an obtaining module may also be described as “a module for obtaining a first indicator sequence”.

The functions described herein above may be executed, at least partially, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine readable medium may be a tangible medium that may contain or store a program for use by or in combination with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the above. More specific examples of the machine readable storage medium may include an electrical connection based on one or more wires, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above.

In a first aspect, one or more embodiments of the present disclosure provide a time sequence prediction method for a service resource indicator. The method includes:
obtaining a first indicator sequence monitored in a service, where the first indicator sequence is used to characterize a measurement value of a specified resource indicator of the service within a historical preset time period;
invoking a time domain prediction model to perform prediction based on a time domain feature of the first indicator sequence to obtain a first prediction sequence of the specified resource indicator generated by the service within a future preset time period;
invoking a frequency domain prediction model to perform prediction based on a frequency domain feature of the first indicator sequence to obtain a second prediction sequence of the specified resource indicator generated by the service within the future preset time period; and
weighting the first prediction sequence and the second prediction sequence to obtain a prediction sequence corresponding to the service, where the prediction sequence is used to guide the service to adjust the specified resource indicator.

According to one or more embodiments of the present disclosure, the invoking a frequency domain prediction model to perform prediction based on a frequency domain feature of the first indicator sequence to obtain a second prediction sequence of the specified resource indicator generated by the service within the future preset time period includes: performing discrete Fourier transform on the first indicator sequence to obtain a first frequency domain feature aligned with a frequency domain of the first indicator sequence, where a length of the first frequency domain feature matches a sum of a length of the first indicator sequence and a length of the second prediction sequence to be predicted; and obtaining the second prediction sequence of the specified resource indicator generated by the service within the future preset time period according to the first frequency domain feature and the frequency domain prediction model.

According to one or more embodiments of the present disclosure, the obtaining the second prediction sequence of the specified resource indicator generated by the service within the future preset time period according to the first frequency domain feature and the frequency domain prediction model includes: performing linear transformation on the first frequency domain feature to obtain a second frequency domain feature of a target dimension matching an input parameter of the frequency domain prediction model; obtaining a prediction frequency domain feature of the specified resource indicator generated by the service within the future preset time period according to the second frequency domain feature of the target dimension and the frequency domain prediction model; and performing inverse Fourier transform on the prediction frequency domain feature to obtain the second prediction sequence of the specified resource indicator generated by the service within the future preset time period.

According to one or more embodiments of the present disclosure, the obtaining a prediction frequency domain feature of the specified resource indicator generated by the service within the future preset time period according to the second frequency domain feature of the target dimension and the frequency domain prediction model includes: using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism.

According to one or more embodiments of the present disclosure, the weighting the first prediction sequence and the second prediction sequence to obtain a prediction sequence corresponding to the service includes: performing Fourier transform on the first indicator sequence to obtain a third frequency domain feature corresponding to the first indicator sequence, where the third frequency domain feature includes a periodic harmonic signal and a non-harmonic signal other than the harmonic signal; determining a first energy parameter corresponding to the non-harmonic signal in the third frequency domain feature and a second energy parameter corresponding to the harmonic signal in the third frequency domain feature; and determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

According to one or more embodiments of the present disclosure, the determining a first weight corresponding to the first prediction sequence and a second weight corresponding to the second prediction sequence according to the first energy parameter and the second energy parameter includes: determining a total energy parameter of the first energy parameter and the second energy parameter; and determining a ratio of the first energy parameter to the total energy parameter as the first weight corresponding to the first prediction sequence, and determining a ratio of the second energy parameter to the total energy parameter as the second weight corresponding to the second prediction sequence.

According to one or more embodiments of the present disclosure, the invoking a time domain prediction model to perform prediction based on a time domain feature of the first indicator sequence to obtain a first prediction sequence of the specified resource indicator generated by the service within a future preset time period includes: segmenting the first indicator sequence into N sub-indicator sequences each with a preset length, where N is a positive integer; performing linear transformation processing on the N sub-indicator sequences with the preset length to obtain N vectors corresponding to the N sub-indicator sequences; and obtaining the first prediction sequence of the specified resource indicator generated by the service within the future preset time period according to the N vectors corresponding to the N sub-indicator sequences and the time domain prediction model.

According to one or more embodiments of the present disclosure, the obtaining the first prediction sequence of the specified resource indicator generated by the service within the future preset time period according to the N vectors corresponding to the N sub-indicator sequences and the time domain prediction model includes: normalizing the N vectors corresponding to the N sub-indicator sequences to obtain N normalized vectors; and obtaining the first prediction sequence of the specified resource indicator generated by the service within the future preset time period according to the N normalized vectors and the time domain prediction model.

According to one or more embodiments of the present disclosure, the first indicator sequence is used to characterize the measurement value of the load information of the target container within the historical preset time period, and the prediction sequence corresponding to the service includes the prediction value of the load information of the target container within the future preset time period. Correspondingly, the method further includes: increasing the resource information of the target container when the prediction value of the load information of the target container within the future preset time period is greater than or equal to a first preset threshold; and reducing the resource information of the target container when the prediction value of the load information of the target container within the future preset time period is less than or equal to a second preset threshold, where the resource information includes a memory resource and/or a processor resource.

In a second aspect, one or more embodiments of the present disclosure provide a time sequence prediction apparatus for a service resource indicator. The apparatus includes:
an obtaining module, configured to obtain a first indicator sequence monitored in a service, where the first indicator sequence is used to characterize a measurement value of a specified resource indicator of the service within a historical preset time period;
a first determination module, configured to invoke a time domain prediction model to perform prediction based on a time domain feature of the first indicator sequence to obtain a first prediction sequence of the specified resource indicator generated by the service within a future preset time period;
a second determination module, configured to invoke a frequency domain prediction model to perform prediction based on a frequency domain feature of the first indicator sequence to obtain a second prediction sequence of the specified resource indicator generated by the service within the future preset time period; and
a prediction module, configured to weight the first prediction sequence and the second prediction sequence to obtain a prediction sequence corresponding to the service, where the prediction sequence is used to guide the service to adjust the specified resource indicator.

According to one or more embodiments of the present disclosure, the second determination module invokes a frequency domain prediction model to perform prediction based on a frequency domain feature of the first indicator sequence to obtain a second prediction sequence of the specified resource indicator generated by the service within the future preset time period, specifically including: performing discrete Fourier transform on the first indicator sequence to obtain a first frequency domain feature aligned with a frequency domain of the first indicator sequence, where a length of the first frequency domain feature matches a sum of a length of the first indicator sequence and a length of the second prediction sequence to be predicted; and obtaining the second prediction sequence of the specified resource indicator generated by the service within the future preset time period according to the first frequency domain feature and the frequency domain prediction model.

According to one or more embodiments of the present disclosure, the second determination module obtains the second prediction sequence of the specified resource indicator generated by the service within the future preset time period according to the first frequency domain feature and the frequency domain prediction model, specifically including: performing linear transformation on the first frequency domain feature to obtain a second frequency domain feature of a target dimension matching an input parameter of the frequency domain prediction model; obtaining a prediction frequency domain feature of the specified resource indicator generated by the service within the future preset time period according to the second frequency domain feature of the target dimension and the frequency domain prediction model; and performing inverse Fourier transform on the prediction frequency domain feature to obtain the second prediction sequence of the specified resource indicator generated by the service within the future preset time period.

According to one or more embodiments of the present disclosure, the second determination module obtains the prediction frequency domain feature of the specified resource indicator generated by the service within the future preset time period according to the second frequency domain feature of the target dimension and the frequency domain prediction model, specifically including: using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism.

According to one or more embodiments of the present disclosure, the prediction module weights the first prediction sequence and the second prediction sequence to obtain the prediction sequence corresponding to the service, specifically including: performing Fourier transform on the first indicator sequence to obtain a third frequency domain feature corresponding to the first indicator sequence, where the third frequency domain feature includes a periodic harmonic signal and a non-harmonic signal other than the harmonic signal; determining a first energy parameter corresponding to the non-harmonic signal in the third frequency domain feature and a second energy parameter corresponding to the harmonic signal in the third frequency domain feature; and determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

According to one or more embodiments of the present disclosure, the prediction module determines a first weight corresponding to the first prediction sequence and a second weight corresponding to the second prediction sequence according to the first energy parameter and the second energy parameter, specifically including: determining a total energy parameter of the first energy parameter and the second energy parameter; and determining a ratio of the first energy parameter to the total energy parameter as the first weight corresponding to the first prediction sequence, and determining a ratio of the second energy parameter to the total energy parameter as the second weight corresponding to the second prediction sequence.

According to one or more embodiments of the present disclosure, the first determination module invokes a time domain prediction model to perform prediction based on a time domain feature of the first indicator sequence to obtain a first prediction sequence of the specified resource indicator generated by the service within a future preset time period, specifically including: segmenting the first indicator sequence into N sub-indicator sequences each with a preset length, where N is a positive integer; performing linear transformation processing on the N sub-indicator sequences with the preset length to obtain N vectors corresponding to the N sub-indicator sequences; and obtaining the first prediction sequence of the specified resource indicator generated by the service within the future preset time period according to the N vectors corresponding to the N sub-indicator sequences and the time domain prediction model.

According to one or more embodiments of the present disclosure, the first determination module obtains the first prediction sequence of the specified resource indicator generated by the service within the future preset time period according to the N vectors corresponding to the N sub-indicator sequences and the time domain prediction model, specifically including: normalizing the N vectors corresponding to the N sub-indicator sequences to obtain N normalized vectors; and obtaining the first prediction sequence of the specified resource indicator generated by the service within the future preset time period according to the N normalized vectors and the time domain prediction model.

According to one or more embodiments of the present disclosure, the first indicator sequence is used to characterize the measurement value of the load information of the target container within the historical preset time period, and the prediction sequence corresponding to the service includes the prediction value of the load information of the target container within the future preset time period. Correspondingly, the apparatus further includes: an adjustment module. The adjustment module is configured to: increase the resource information of the target container when the prediction value of the load information of the target container within the future preset time period is greater than or equal to a first preset threshold; and reduce the resource information of the target container when the prediction value of the load information of the target container within the future preset time period is less than or equal to a second preset threshold, where the resource information includes a memory resource and/or a processor resource.

In a third aspect, one or more embodiments of the present disclosure provide an electronic device. The electronic device includes: a processor, and a memory communicatively connected to the processor,
where the memory stores computer executable instructions; and
the processor executes the computer executable instructions stored in the memory to implement the time sequence prediction method for a service resource indicator according to the first aspect described above and various possible designs of the first aspect.

In a fourth aspect, one or more embodiments of the present disclosure provide a computer-readable storage medium. Computer executable instructions are stored in the computer-readable storage medium. When the computer executable instructions are executed by a processor, the time sequence prediction method for a service resource indicator according to the first aspect described above and various possible designs of the first aspect is implemented.

In a fifth aspect, an embodiment of the present disclosure provides a computer program product. The computer program product includes a computer program. When the computer program is executed by a processor, the time sequence prediction method for a service resource indicator according to the first aspect described above and various possible designs of the first aspect is implemented.

The above description is merely a description of preferred embodiments of the present disclosure and the applied technical principles. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalent features, for example, a technical solution formed by replacing the above-mentioned features with technical features having similar functions disclosed in the present disclosure (but not limited to).

In addition, although operations are depicted in a specific order, this should not be understood as requiring that these operations should be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms for implementing the claims.

1. A time sequence prediction method for a service resource indicator, comprising:
obtaining a first indicator sequence monitored in a service, wherein the first indicator sequence is used to characterize a measurement value of a specified resource indicator of the service within a historical preset time period;
invoking a time domain prediction model to perform prediction based on a time domain feature of the first indicator sequence to obtain a first prediction sequence of the specified resource indicator generated by the service within a future preset time period;
invoking a frequency domain prediction model to perform prediction based on a frequency domain feature of the first indicator sequence to obtain a second prediction sequence of the specified resource indicator generated by the service within the future preset time period; and
weighting the first prediction sequence and the second prediction sequence to obtain a prediction sequence corresponding to the service, wherein the prediction sequence is used to guide the service to adjust the specified resource indicator.

2. The method according to claim 1, wherein the invoking the frequency domain prediction model to perform prediction based on the frequency domain feature of the first indicator sequence to obtain the second prediction sequence of the specified resource indicator generated by the service within the future preset time period comprises:
performing discrete Fourier transform on the first indicator sequence to obtain a first frequency domain feature aligned with a frequency domain of the first indicator sequence, wherein a length of the first frequency domain feature matches a sum of a length of the first indicator sequence and a length of the second prediction sequence to be predicted; and
obtaining the second prediction sequence of the specified resource indicator generated by the service within the future preset time period according to the first frequency domain feature and the frequency domain prediction model.

3. The method according to claim 2, wherein the obtaining the second prediction sequence of the specified resource indicator generated by the service within the future preset time period according to the first frequency domain feature and the frequency domain prediction model comprises:
performing linear transformation on the first frequency domain feature to obtain a second frequency domain feature of a target dimension matching an input parameter of the frequency domain prediction model;
obtaining a prediction frequency domain feature of the specified resource indicator generated by the service within the future preset time period according to the second frequency domain feature of the target dimension and the frequency domain prediction model; and
performing inverse Fourier transform on the prediction frequency domain feature to obtain the second prediction sequence of the specified resource indicator generated by the service within the future preset time period.

4. The method according to claim 3, wherein the obtaining the prediction frequency domain feature of the specified resource indicator generated by the service within the future preset time period according to the second frequency domain feature of the target dimension and the frequency domain prediction model comprises:
using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism.

5. The method according to claim 1, wherein the weighting the first prediction sequence and the second prediction sequence to obtain the prediction sequence corresponding to the service comprises:
performing Fourier transform on the first indicator sequence to obtain a third frequency domain feature corresponding to the first indicator sequence, wherein the third frequency domain feature comprises a periodic harmonic signal and a non-harmonic signal other than the harmonic signal;
determining a first energy parameter corresponding to the non-harmonic signal in the third frequency domain feature and a second energy parameter corresponding to the harmonic signal in the third frequency domain feature; and
determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

6. The method according to claim 5, wherein the determining the first weight corresponding to the first prediction sequence and the second weight corresponding to the second prediction sequence according to the first energy parameter and the second energy parameter comprises:
determining a total energy parameter of the first energy parameter and the second energy parameter; and
determining a ratio of the first energy parameter to the total energy parameter as the first weight corresponding to the first prediction sequence, and determining a ratio of the second energy parameter to the total energy parameter as the second weight corresponding to the second prediction sequence.

7. The method according to claim 1, wherein the invoking the time domain prediction model to perform prediction based on the time domain feature of the first indicator sequence to obtain the first prediction sequence of the specified resource indicator generated by the service within the future preset time period comprises:
segmenting the first indicator sequence into N sub-indicator sequences each with a preset length, wherein N is a positive integer;
performing linear transformation processing on the N sub-indicator sequences with the preset length to obtain N vectors corresponding to the N sub-indicator sequences; and
obtaining the first prediction sequence of the specified resource indicator generated by the service within the future preset time period according to the N vectors corresponding to the N sub-indicator sequences and the time domain prediction model.

8. The method according to claim 7, wherein the obtaining the first prediction sequence of the specified resource indicator generated by the service within the future preset time period according to the N vectors corresponding to the N sub-indicator sequences and the time domain prediction model comprises:
normalizing the N vectors corresponding to the N sub-indicator sequences to obtain N normalized vectors; and
obtaining the first prediction sequence of the specified resource indicator generated by the service within the future preset time period according to the N normalized vectors and the time domain prediction model.

9. The method according to claim 1, wherein the first indicator sequence is used to characterize a measurement value of load information of a target container within the historical preset time period, and the prediction sequence corresponding to the service comprises a prediction value of load information of the target container within the future preset time period; and correspondingly, the method further comprises:
increasing resource information of the target container when the prediction value of the load information of the target container within the future preset time period is greater than or equal to a first preset threshold; and
reducing the resource information of the target container when the prediction value of the load information of the target container within the future preset time period is less than or equal to a second preset threshold,
wherein the resource information comprises a memory resource and/or a processor resource.

10. The method according to claim 2, wherein the weighting the first prediction sequence and the second prediction sequence to obtain the prediction sequence corresponding to the service comprises:
performing Fourier transform on the first indicator sequence to obtain a third frequency domain feature corresponding to the first indicator sequence, wherein the third frequency domain feature comprises a periodic harmonic signal and a non-harmonic signal other than the harmonic signal;
determining a first energy parameter corresponding to the non-harmonic signal in the third frequency domain feature and a second energy parameter corresponding to the harmonic signal in the third frequency domain feature; and
determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

11. An electronic device, comprising: a processor, and a memory communicatively connected to the processor,
wherein the memory stores computer executable instructions; and
the processor executes the computer executable instructions stored in the memory to implement a time sequence prediction method for a service resource indicator, wherein the time sequence prediction method comprises:
obtaining a first indicator sequence monitored in a service, wherein the first indicator sequence is used to characterize a measurement value of a specified resource indicator of the service within a historical preset time period;
invoking a time domain prediction model to perform prediction based on a time domain feature of the first indicator sequence to obtain a first prediction sequence of the specified resource indicator generated by the service within a future preset time period;
invoking a frequency domain prediction model to perform prediction based on a frequency domain feature of the first indicator sequence to obtain a second prediction sequence of the specified resource indicator generated by the service within the future preset time period; and
weighting the first prediction sequence and the second prediction sequence to obtain a prediction sequence corresponding to the service, wherein the prediction sequence is used to guide the service to adjust the specified resource indicator.

12. The electronic device according to claim 11, wherein the invoking the frequency domain prediction model to perform prediction based on the frequency domain feature of the first indicator sequence to obtain the second prediction sequence of the specified resource indicator generated by the service within the future preset time period comprises:
performing discrete Fourier transform on the first indicator sequence to obtain a first frequency domain feature aligned with a frequency domain of the first indicator sequence, wherein a length of the first frequency domain feature matches a sum of a length of the first indicator sequence and a length of the second prediction sequence to be predicted; and
obtaining the second prediction sequence of the specified resource indicator generated by the service within the future preset time period according to the first frequency domain feature and the frequency domain prediction model.

13. The electronic device according to claim 12, wherein the obtaining the second prediction sequence of the specified resource indicator generated by the service within the future preset time period according to the first frequency domain feature and the frequency domain prediction model comprises:
performing linear transformation on the first frequency domain feature to obtain a second frequency domain feature of a target dimension matching an input parameter of the frequency domain prediction model;
obtaining a prediction frequency domain feature of the specified resource indicator generated by the service within the future preset time period according to the second frequency domain feature of the target dimension and the frequency domain prediction model; and
performing inverse Fourier transform on the prediction frequency domain feature to obtain the second prediction sequence of the specified resource indicator generated by the service within the future preset time period.

14. The electronic device according to claim 13, wherein the obtaining the prediction frequency domain feature of the specified resource indicator generated by the service within the future preset time period according to the second frequency domain feature of the target dimension and the frequency domain prediction model comprises:
using the second frequency domain feature of the target dimension as an input of the frequency domain prediction model, and obtaining, by the frequency domain prediction model, the prediction frequency domain feature of the specified resource indicator generated by the service within the future preset time period by acquiring information from a plurality of frequency domain combinations based on a complex spectrum attention mechanism.

15. The electronic device according to claim 11, wherein the weighting the first prediction sequence and the second prediction sequence to obtain the prediction sequence corresponding to the service comprises:
performing Fourier transform on the first indicator sequence to obtain a third frequency domain feature corresponding to the first indicator sequence, wherein the third frequency domain feature comprises a periodic harmonic signal and a non-harmonic signal other than the harmonic signal;
determining a first energy parameter corresponding to the non-harmonic signal in the third frequency domain feature and a second energy parameter corresponding to the harmonic signal in the third frequency domain feature; and
determining a first weight corresponding to the first prediction sequence and a second weight corresponding to the second prediction sequence according to the first energy parameter and the second energy parameter, and weighting the first prediction sequence and the second prediction sequence according to the first weight and the second weight to obtain the prediction sequence corresponding to the service.

16. The electronic device according to claim 15, wherein the determining the first weight corresponding to the first prediction sequence and the second weight corresponding to the second prediction sequence according to the first energy parameter and the second energy parameter comprises:
determining a total energy parameter of the first energy parameter and the second energy parameter; and
determining a ratio of the first energy parameter to the total energy parameter as the first weight corresponding to the first prediction sequence, and determining a ratio of the second energy parameter to the total energy parameter as the second weight corresponding to the second prediction sequence.

17. The electronic device according to claim 11, wherein the invoking the time domain prediction model to perform prediction based on the time domain feature of the first indicator sequence to obtain the first prediction sequence of the specified resource indicator generated by the service within the future preset time period comprises:
segmenting the first indicator sequence into N sub-indicator sequences each with a preset length, wherein N is a positive integer;
performing linear transformation processing on the N sub-indicator sequences with the preset length to obtain N vectors corresponding to the N sub-indicator sequences; and
obtaining the first prediction sequence of the specified resource indicator generated by the service within the future preset time period according to the N vectors corresponding to the N sub-indicator sequences and the time domain prediction model.

18. The electronic device according to claim 17, wherein the obtaining the first prediction sequence of the specified resource indicator generated by the service within the future preset time period according to the N vectors corresponding to the N sub-indicator sequences and the time domain prediction model comprises:
normalizing the N vectors corresponding to the N sub-indicator sequences to obtain N normalized vectors; and
obtaining the first prediction sequence of the specified resource indicator generated by the service within the future preset time period according to the N normalized vectors and the time domain prediction model.

19. The electronic device according to claim 11, wherein the first indicator sequence is used to characterize a measurement value of load information of a target container within the historical preset time period, and the prediction sequence corresponding to the service comprises a prediction value of load information of the target container within the future preset time period; and correspondingly, the method further comprises:
increasing resource information of the target container when the prediction value of the load information of the target container within the future preset time period is greater than or equal to a first preset threshold; and
reducing the resource information of the target container when the prediction value of the load information of the target container within the future preset time period is less than or equal to a second preset threshold,
wherein the resource information comprises a memory resource and/or a processor resource.

20. A computer-readable storage medium, wherein computer executable instructions are stored in the computer-readable storage medium, and when the computer executable instructions are executed by a processor, a time sequence prediction method for a service resource indicator, wherein the time sequence prediction method comprises:
obtaining a first indicator sequence monitored in a service, wherein the first indicator sequence is used to characterize a measurement value of a specified resource indicator of the service within a historical preset time period;
invoking a time domain prediction model to perform prediction based on a time domain feature of the first indicator sequence to obtain a first prediction sequence of the specified resource indicator generated by the service within a future preset time period;
invoking a frequency domain prediction model to perform prediction based on a frequency domain feature of the first indicator sequence to obtain a second prediction sequence of the specified resource indicator generated by the service within the future preset time period; and
weighting the first prediction sequence and the second prediction sequence to obtain a prediction sequence corresponding to the service, wherein the prediction sequence is used to guide the service to adjust the specified resource indicator.
